(19) United States
(12) Patent Application Publication
(10) Pub. No.: US 2024/0046661 A1
(43) Pub. Date: Feb. 8, 2024

(54) DISPLAY CONTROL SYSTEM, DISPLAY CONTROL METHOD, AND RECORDING MEDIUM

(71) Applicant: Panasonic Intellectual Property Management Co., Ltd., Osaka (JP)

(72) Inventors: Masakazu NAKAZAWA, Osaka (JP); Kenji OGA, Osaka (JP); Yasuhiro ITO, Osaka (JP); Naoki IKEMOTO, Osaka (JP)

(73) Assignee: Panasonic Intellectual Property Management Co., Ltd., Osaka (JP)

(21) Appl. No.: 18/228,764

(22) Filed: Aug. 1, 2023

(30) Foreign Application Priority Data
Aug. 8, 2022 (JP) 2022-126084

(51) Int. Cl. G06V 20/59; G06T 7/70; G06F 3/14; G06V 10/56; G06V 10/60

(52) U.S. Cl. CPC G06V 20/59; G06T 7/70; G06F 3/14; G06V 10/56; G06V 10/60; G06T 2207/30201

(57) ABSTRACT

A display control system is a display control system which is for controlling a first display region and a second display region (a first display screen and a second display screen) arranged in a vehicle, and which includes: an analyzer which obtains captured images of the first display region which displays a video and the second display region which displays a video, and analyzes, based on the captured images obtained, display modes which are a display mode of the video displayed in the first display region and a display mode of the video displayed in the second display region; and an information generator which generates, for each of the display modes, display adjustment information for adjusting the display mode, based on at least a result of analysis by the analyzer, and outputs the display adjustment information generated.

### CROSS REFERENCE TO RELATED APPLICATION

The present application is based on and claims priority of Japanese Patent Application No. 2022-126084 filed on Aug. 8, 2022.

### FIELD

The present disclosure relates to display control systems, display control methods, and recording media.

### BACKGROUND

Patent Literature 1 discloses an electronic device which is capable of presenting accurate display even when different-kind monitors are connected thereto. The electronic device includes: an obtainer which obtains extended display identification data (EDID) from each of display devices; and a generator which compares the EDID obtained by the obtainer, and generates new EDID including resolution information which is common between the display devices.

### CITATION LIST

### Patent Literature

PTL 1: Japanese Unexamined Patent Application Publication No. 2018-169471

### SUMMARY

The above-described electronic device according to PTL 1 can be improved upon.

In view of this, the present disclosure provides a display control system, etc., capable of improving upon the above related art.

A display control system according to one aspect of the present disclosure is a display control system which is for controlling a first display region and a second display region arranged in a vehicle, and which includes: an analyzer which obtains captured images of the first display region which displays a video and the second display region which displays a video, and analyzes, based on the captured images obtained, display modes which are a display mode of the video displayed in the first display region and a display mode of the video displayed in the second display region; and an information generator which generates, for each of the display modes, display adjustment information for adjusting the display mode, based on at least a result of analysis by the analyzer, and outputs the display adjustment information generated.

Furthermore, a display control method according to one aspect of the present disclosure is a display control method which is for controlling a first display region and a second display region arranged in a vehicle, and includes: obtaining captured images of the first display region which displays a video and the second display region which displays a video; analyzing, based on the captured images obtained, display modes which are a display mode of the video displayed in the first display region and a display mode of the video displayed in the second display region; and generating, for each of the display modes, display adjustment information for adjusting the display mode, based on at least a result of the analyzing, and outputting the display adjustment information generated.

Furthermore, a recording medium according to one aspect of the present disclosure stores recorded thereon a program for causing a computer to execute the display control method.

The display control system, etc., according to the one or more aspects of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating a display system according to an embodiment mounted on a vehicle.

FIG. 2 is a block diagram indicating the display system according to the embodiment.

FIG. 3 is a flowchart indicating an example of an operation that is performed by the display system according to the embodiment.

FIG. 4 is a schematic diagram illustrating a display system according to Variation 1 of the embodiment.

FIG. 5 is a flowchart indicating an example of an operation that is performed by the display system according to Variation 1 of the embodiment.

FIG. 6 is a flowchart indicating an example of an operation that is performed by a display system according to Variation 2 of the embodiment.

FIG. 7 is a block diagram illustrating a display system according to Variation 3 of the embodiment.

FIG. 8 is a schematic diagram illustrating the display system according to Variation 3 of the embodiment.

FIG. 9 is a schematic diagram illustrating a state in which a part of a display screen is irradiated with ambient light.

FIG. 10 is a flowchart indicating an example of an operation that is performed by the display system according to Variation 3 of the embodiment.

### DESCRIPTION OF EMBODIMENT

It is to be noted that the embodiment and variations thereof each indicates a generic or specific example. The numerical values, shapes, materials, elements, the arrangement and connection of the elements, steps, the execution order of the steps, etc., indicated in the following embodiment and variations thereof are mere examples, and therefore do not limit the scope of the present disclosure. In addition, among the elements in the embodiment and variations thereof, elements not recited in any one of the independent claims are described as optional elements.

In addition, each diagram is a schematic diagram, and thus is not always illustrated precisely. In addition, in each diagram, the same constituent members are assigned with the same reference signs.

Hereinafter, an embodiment is described with reference to the drawings.

### Embodiment

### <Configuration and Functions>

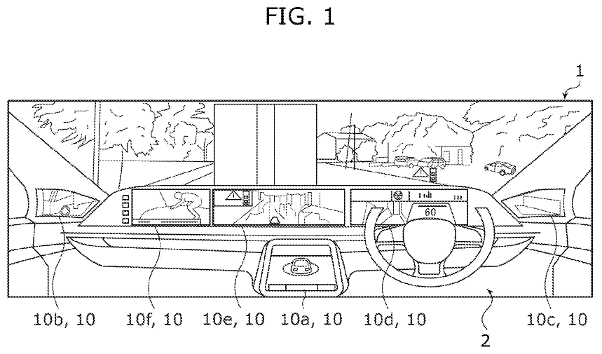

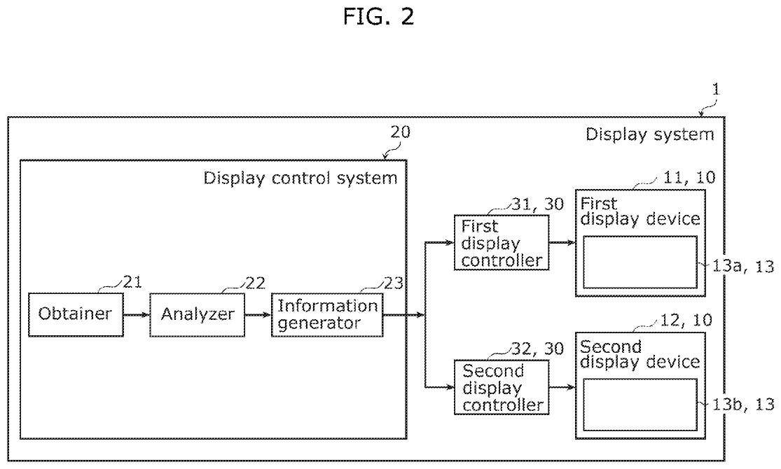

First, display system 1 according to an embodiment is described with reference to FIGS. 1 and 2.

FIG. 1 is a schematic diagram illustrating display system 1 according to the embodiment disposed in vehicle 2. FIG. 2 is a block diagram indicating display system 1 according to the embodiment.

As illustrated in FIG. 1, display system 1 is a system for displaying a video on each of one or more display screens 13 of each of one or more display devices 10. Display system 1 is capable of setting the position of the video displayed on each of one or more display screens 13 of each of one or more display devices 10 automatically or manually by an occupant.

In addition, display system 1 is used for vehicle 2, or the like on which one or more display devices 10 are arranged. For this reason, in the present embodiment, each video is an image that is displayed based on an application. The video includes, for example, information about instruments for vehicles, operation states of in-vehicle devices, navigation, captured images, and surrounding vehicles, etc. The instruments for vehicles are a speed meter, a turn signal light, a warning light, an odometer, a shift position, a fuel gauge, a water temperature gauge, etc. The in-vehicle devices are, for example, sound equipment, in-vehicle lighting devices, seat devices, etc. Navigation information is information for providing a driver with route guidance, etc., of a current position and to a destination during driving by vehicle 2. Captured images are images obtained by an imaging device mounted in vehicle 2 capturing images of surroundings of and inside of vehicle 2. The surrounding vehicle information is information indicating, for example, presence/absence of one or more other surrounding vehicles present near vehicle 2, the number of surrounding vehicles, the speed of each surrounding vehicle, the distance from vehicle 2 to each surrounding vehicle.

Specifically, display system 1 includes a plurality of display devices 10, display control system 20, and a plurality of display controllers 30. FIG. 2 illustrates a case in which display system 1 includes: first display device 11 and second display device 12 which are an example of the plurality of display devices 10; display control system 20; and first display controller 31 and second display controller 32 which are an example of the plurality of display controllers 30. In this embodiment, first display device 11 and second display device 12 may be collectively referred to as display devices 10. In addition, in this embodiment, first display controller 31 and second display controller 32 may be collectively referred to as display controllers 30.

### [First Display Device 11 and Second Display Device 12]

First display device 11 and second display device 12 are each a display that is for example a personal computer (PC) on which a liquid crystal display or the like is mounted, a mobile terminal such as a smartphone, and a car navigation system, an electronic mirror system, multi information displays, etc., that are mounted on vehicle 2.

FIG. 1 illustrates, as the plurality of displays 10, car navigation system 10a, the electronic mirror system that functions as left side mirror 10b and right side mirror 10c, and a plurality of multi information displays 10d, 10e, and 10f. The plurality of display devices 10 are arranged aligned so that an occupant of vehicle 2 can see the plurality of display devices 10 collectively at once.

As illustrated in FIG. 1, when the plurality of display devices 10 are arranged aligned, the plurality of display devices 10 are capable of displaying a single video by being link-controlled by display system 1, or displaying videos individually.

FIG. 2 illustrates first display device 11 and second display device 12 as the plurality of display devices 10. As illustrated in FIG. 2, first display device 11 includes first display screen 13a. In addition, second display device 12 includes second display screen 13b. First display screen 13a which displays a video is one example of a first display region. Likewise, second display screen 13b which displays a video is one example of a second display region. In the present embodiment, first display screen 13a and second display screen 13b may be collectively referred to as display screens 13.

First display screen 13a and second display screen 13b are each a display capable of displaying a video thereon. First display screen 13a and second display screen 13b are each a display panel that is, for example, a liquid crystal panel, an electro luminescent (EL) panel, or the like. First display screen 13a and second display screen 13b each displays, for example, a map for car navigation, a menu image of each of various kinds of in-vehicle devices, or a graphical user interface (GUI) for operating a video such as a search image.

### [Display Control System 20]

Display control system 20 is a system which is disposed in vehicle 2 including the plurality of display screens 13. Display control system 20 is capable of adjusting and controlling the display mode of a video displayed on first display screen 13a of first display device 11 and the display mode of a video displayed on second display screen 13b of second display device 12.

Specifically, display control system 20 includes obtainer 21, analyzer 22, and information generator 23.

Obtainer 21 is an input interface or a camera capable of obtaining captured images of first display screen 13a and second display screen 13b for displaying videos. In the present embodiment, a description is given mainly assuming a case in which obtainer 21 is an in-vehicle camera capable of capturing an image of inside vehicle 2.

When obtainer 21 is an in-vehicle camera capable of capturing an image of inside the room of vehicle 2, obtainer 21 is capable of obtaining captured images in which display screens for displaying videos are included by capturing images of first display screen 13a and second display screen 13b arranged inside the room of vehicle 2.

On the other hand, when obtainer 21 is an input interface, obtainer 21 may be capable of obtaining images captured by an imager to include first display screen 13a and second display screen 13b arranged in the room of vehicle 2.

Obtainer 21 outputs the captured images obtained to analyzer 22.

Analyzer 22 obtains captured images of first display screen 13a and second display screen 13b for displaying videos. Analyzer 22 analyzes each of the display mode of the video displayed on first display screen 13a and the display mode of the video displayed on second display screen 13b. Here, each of the display mode of the video displayed on first display screen 13a and the display mode of the video displayed on second display screen 13b is at least one of a position, posture, or size of a corresponding one of first display screen 13a and second display screen 13b, color information about or luminance of the video displayed in the corresponding one of the first display region and the second display region, or presence/absence of a failure of the corresponding one of first display screen 13a and second display screen 13b. In other words, based on the captured images, analyzer 22 analyzes at least one of the position, posture, or size of each of display screens 13, color information about or luminance of the video displayed on display screen 13, or presence/absence of a failure of display screen 13. The position of display screen 13 is, for example, a position relative to the position of obtainer 21 or a predetermined position inside the room of vehicle 2. The posture of display screen 13 is, for example, an orientation or a tilt of display screen 13 relative to a horizontal plane or a vertical plane. The size of display screen 13 is a physical size for displaying a video. The color information of a video is a value in a color space of the video displayed on display screen 13 (the color space is, for example, a red, green, and blur (RGB) space, a space of a luminance signal, a color difference between a blue signal and the luminance signal, color difference between a red signal and the luminance signal (YUV), or the like). The luminance of the video is a brightness of the video displayed on display screen 13. The presence/absence of a failure of display screen 13 indicates whether the video is being displayed normally.

In addition, analyzer 22 identifies the position of first display screen 13a and second display screen 13b by analyzing the position of first display screen 13a and the position of second display screen 13b based on the captured images obtained. Analyzer 22 compares the position of first display screen 13a and the position of second display screen 13b identified and position information of first display screen 13a and position information about second display screen 13b stored in a storage such as a not-illustrated memory, and associates first display screen 13a in one of the captured images with first display screen 13a that is to be adjusted actually and associates second display screen 13b in the other one of the captured images with second display screen 13b that is to be adjusted actually.

In FIG. 1, since first display screen 13a and second display screen 13b are illustrated, the captured images include first display screen 13a that is displaying a video and second display screen 13b that is displaying a video. Analyzer 22 analyzes the display mode of the video displayed on first display screen 13a and the display mode of the video displayed on second display screen 13b, based on the captured images obtained. Analyzer 22 outputs the result of analyzing the captured images.

Information generator 23 obtains, from analyzer 22, the result indicating the display mode of the video displayed on first display screen 13a and the display mode of the video displayed on second display screen 13b. Information generator 23 generates first display adjustment information for adjusting the display mode of the video displayed on first display screen 13a, based on at least the result of the analysis by analyzer 22. Information generator 23 generates second display adjustment information for adjusting the display mode of the video displayed on second display screen 13b, based on at least the result of the analysis by analyzer 22.

Each of first display screen 13a and second display screen 13b is likely to receive ambient light that varies depending on the position thereof or changes while vehicle 2 is running. For this reason, to maintain the whole sense of unity of the display mode of the video that is displayed on first display screen 13a and the display mode of the video that is displayed on second display screen 13b, information generator 23 may generate display adjustment information suitable for first display screen 13a and display adjustment information suitable for second display screen 13b, based on the result of the analysis by analyzer 22. Here, the display adjustment information suitable for first display screen 13a is information for adjusting the video displayed on first display screen 13a and the display adjustment information suitable for second display screen 13b is information for adjusting the video displayed on second display screen 13b, so that each video is displayed in display mode that is suitable for a corresponding one of first display screen 13a and second display screen 13b. For this reason, the display adjustment information suitable for first display screen 13a and the display adjustment information suitable for second display screen 13b each include brightness, contrast, gamma values, color information, etc., for individually adjusting a corresponding one of the display mode of the video that is displayed on first display screen 13a and the display mode of the video that is displayed on second display screen 13b.

Information generator 23 outputs the display adjustment information suitable for first display screen 13a and the display adjustment information suitable for second display screen 13b. Specifically, information generator 23 outputs the first display adjustment information generated to first display controller 31 and outputs the second display adjustment information generated to second display controller 32.

### [First Display Controller 31 and Second Display Controller 32]

As illustrated in FIG. 2, first display controller 31 controls the display mode of a video that is displayed by first display screen 13a of first display device 11. Likewise, second display controller 32 controls the display mode of a video that is displayed by second display screen 13b of second display device 12.

Specifically, based on the display adjustment information output by information generator 23, first display controller 31 generates a rendering command for executing processing for rendering the video that is displayed on first display screen 13a. Likewise, based on the display adjustment information output by information generator 23, second display controller 32 generates a rendering command for executing processing for rendering the video that is displayed on second display screen 13b. Based on the rendering command generated, each of first display controller 31 and second display controller 32 executes the rendering processing for which the brightness, contrast, gamma value, color information, etc., has been adjusted in order to adjust the display mode of the video. First display controller 31 outputs the video on which the rendering processing has been executed to first display device 11. Likewise, second display controller 32 outputs the video on which the rendering processing has been executed to second display device 12.

Although FIG. 2 illustrates first display controller 31 and second display controller 32 as examples, it is to be noted that only single display controller 30 may be provided instead. In such a case, only single display controller 30 controls the display modes of videos that are displayed by first display device 11 and second display device 12.

### <Summary>

Display control system 20 described above is capable of causing first display screen 13a of first display device 11 and second display screen 13b of second display device 12 to display the videos whose display modes have been adjusted. For example, in the case of adjusting the luminance of each of display screens 13 by ambient light incident on display screen 13, display control system 20 is capable of adjusting the video that is displayed on first display screen 13a and the video that is displayed on second display screen 13b, so that an occupant can see the videos as videos having the same brightness when looking at first display screen 13a and second display screen 13b. On the other hand, in the case of adjusting color information of each display screen 13 according to an individual difference of display screen 13, display control system 20 is capable of adjusting the video that is displayed on first display screen 13a and the video that is displayed on second display screen 13b, so that the occupant can see the videos as videos having the same color information when looking at first display screen 13a and second display screen 13b. In this way, the occupant can see the videos having the whole sense of unity when looking at first display screen 13a and second display screen 13b.

### <Processing Operations>

A description is given of processing operations by display control system 20, a display control method, and a program according to the present embodiment.

### Operation Examples

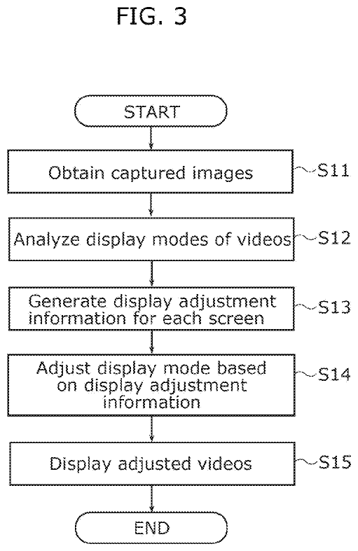

An operation example is described with reference to FIG. 3. FIG. 3 is a flowchart indicating an example of an operation that is performed by display system 1 according to the present embodiment. The present operation example is provided assuming a case where captured images include first display screen 13a of first display device 11 and second display screen 13b of second display device 12.

First, obtainer 21 obtains a captured image of first display screen 13a for displaying a video and a captured image of second display screen 13b for displaying a video (S11).

Specifically, obtainer 21 obtains the captured image of first display screen 13a of first display device 11 for displaying a video and the captured image of second display screen 13b of second display device 12 for displaying a video. When obtainer 21 is a camera, obtainer 21 may obtain the captured image of first display screen 13a and the captured image of second display screen 13b by imaging inside the room of vehicle 2. When obtainer 21 is an interface, obtainer 21 may obtain the captured image of first display screen 13a and the captured image of second display screen 13b through imaging of inside the room of vehicle 2. Obtainer 21 outputs the captured images obtained to analyzer 22.

Next, upon obtaining the captured images, analyzer 22 analyzes the display mode of the video that is displayed on first display screen 13a and the display mode of the video that is displayed on second display screen 13b, based on the captured images obtained.

Specifically, analyzer 22 extracts first display screen 13a and second display screen 13b from the captured images, and analyzes at least one of the position, posture, or size of each of first display screen 13a and second display screen 13b extracted, color information about or luminance of the video displayed in the corresponding one of the first display screen 13a and the second display screen 13b, or presence/absence of a failure of the corresponding one of first display screen 13a and second display screen 13b extracted. Analyzer 22 outputs the result of analyzing the captured images to information generator 23.

Next, information generator 23 obtains, from analyzer 22, the analysis result indicating the display mode of the video displayed on first display screen 13a and the display mode of the video displayed on second display screen 13b. Information generator 23 collectively generates display adjustment information for individually adjusting the display mode of the video displayed on first display screen 13a and display adjustment information for individually adjusting the display mode of the video displayed on second display screen 13b (S13).

Specifically, based on the result of the analysis by analyzer 22, information generator 23 generates the first display adjustment information for adjusting the display mode of the video displayed on first display screen 13a and the second display adjustment information for adjusting the display mode of the video displayed on second display screen 13b. Information generator 23 outputs the first display adjustment information generated to first display controller 31 and outputs the second display adjustment information generated to second display controller 32. In other words, display control system 20 feeds back the display mode of the video displayed on first display screen 13a to first display controller 31, and feeds back the display mode of the video displayed on second display screen 13b to second display controller 32. In this way, to compensate individual differences in the positions, postures, degrees of degradation, etc., between display screens 13, information generator 23 is capable of generating display adjustment information suitable for each of display screens 13, and outputting the display adjustment information suitable for first display screen 13a to first display controller 31, and outputting the display adjustment information suitable for second display screen 13b to second display controller 32.

Next, upon obtaining the display adjustment information for each display screen, display controller 30 generates a rendering command for executing processing for rendering a video that is displayed on a corresponding one of first display screen 13a and second display screen 13b, based on the display adjustment information obtained. Display controller 30 executes the rendering processing based on the rendering command generated, and adjusts the display mode of the video for display on display screen 13 (S14).

Specifically, upon receiving the first display adjustment information, first display controller 31 generates a rendering command for executing processing for rendering the video that is displayed on first display screen 13a, based on the first display adjustment information obtained. Likewise, upon receiving the second display adjustment information, second display controller 32 generates a rendering command for executing processing for rendering the video that is displayed on second display screen 13b, based on the second display adjustment information obtained. Each of first display controller 31 and second display controller 32 executes the rendering processing based on the rendering command generated, and adjusts the display mode of the video for displaying a corresponding one of first display screen 13a and second display screen 13b. First display controller 31 outputs the video on which the rendering processing has been executed to first display device 11. Second display controller 32 outputs the video on which the rendering processing has been executed to second display device 12.

Next, upon obtaining the adjusted videos from display controller 30 based on the display adjustment information for first display screen 13a and the display adjustment information for second display screen 13b, first display device 11 displays the video obtained on first display screen 13a and second display device 12 displays the video on second display screen 13b (S15).

Specifically, first display device 11 displays the video on first display screen 13a upon obtaining the video adjusted based on the first display adjustment information from first display controller 31. Likewise, second display device 12 displays the video on second display screen 13b upon obtaining the video adjusted based on the second display adjustment information from second display controller 32. In other words, display screens 13 are capable of displaying the videos adjusted suitably for the individual differences of display screens 13, and thus are capable of causing the display modes of the videos displayed on display screens 13 to have the whole sense of unity.

The processing operation in the flowchart in FIG. 3 is then ended, and a similar processing operation is repeated from Step S11.

For example, when ambient light is incident on at least one of display screens 13 on which videos are displayed of the plurality of display devices 10, there is a case where an occupant sees the videos as videos having color information, brightness, etc., which are different from video to video. For this reason, display control system 20 is capable of causing the display modes of videos that are displayed on the plurality of display devices 10 to be adjusted by outputting the display adjustment information to display controllers 30 for each of the plurality of display devices 10 so as to maintain the whole sense of unity of display screens 13 that are displaying the videos when the occupant looks at display screens 13 in the plurality of display devices 10.

Display control system 20, the display control method, and the program may be executed, for example, in particular periods of time such as morning, daytime, evening, night, or the like. In addition, the processing operation may be executed when vehicle 2 has entered into a particular state, or when the states of vehicle 2 has changed. The particular state is, for example, a case in which the engine of vehicle 2 has turned on, or a case in which vehicle 2 has started running. The case in which the state of vehicle 2 has changed is, for example, one of cases in which vehicle 2 has exited from a garage, has entered a garage, has stopped temporarily, or has released a temporal stop. In addition, the processing operation may be executed in a case in which a driving environment for vehicle 2 has changed. The case in which the driving environment for vehicle 2 has changed is for example, one of cases in which vehicle 2 has entered a tunnel, is running a bad road. In addition, the processing operation may be always performed.

### <Operational Advantages>

Next, a description is given of operational advantages provided by display control system 20, the display control method, and the program according to the present embodiment.

The electronic device in PTL 1 has a problem of being incapable of providing display having a sense of unity as all the plurality of monitors because there are cases where the monitors are irradiated with ambient light, the degrees of degradation over time of the monitors are different from one another, the arrangement positions of the monitors are different from one another, and other cases when the plurality of monitors display images.

In view of this, as described above, display control system 20 according to the present embodiment is display control system 20 which controls a first display region and a second display region (first display screen 13a and second display screen 13b) arranged in vehicle 2, and includes: analyzer 22 which obtains captured images of the first display region and the second display region, and analyzes the display mode of the video displayed in the first display region and the display mode of the video displayed in the second display region; and information generator 23 which generates display adjustment information for adjusting the display mode of the video displayed in the first display region and display adjustment information for adjusting the display mode of the video displayed in the second display region based on at least the result of the analysis by analyzer 22, and outputs the display adjustment information for adjusting the display mode of the video displayed in the first display region and the display adjustment information for adjusting the display mode of the video displayed in the second display region generated.

With this, it is possible to analyze the display mode of the video displayed on first display screen 13a and the display mode of the video displayed on second display screen 13b, and feed back the display adjustment information for adjusting the display mode of the video displayed on first display screen 13a to first display screen 13a and feed back the display adjustment information for adjusting the display mode of the video displayed on second display screen 13b to second display screen 13b. For this reason, since the adjusted videos are displayed on first display screen 13a and second display screen 13b, the occupant can see the videos having the whole sense of unity when looking at first display screen 13a and second display screen 13b.

Accordingly, display control system 20 according to the present embodiment is capable of providing display having the whole sense of unity regardless of whether the first display region and the second display region are first display screen 13a and second display screen 13b or the first display region and the second display region constitute single display screen 13.

Furthermore, the display control method according to the present embodiment is a display control method which is for controlling the first display region and the second display region for displaying videos, and which includes: obtaining captured images of the first display region which displays a video and the second display region which displays a video; analyzing, based on the captured images obtained, display modes which are a display mode of the video displayed in the first display region and a display mode of the video displayed in the second display region; and generating, for each of the display modes, display adjustment information for adjusting the display mode, based on at least a result of the analyzing, and outputting the display adjustment information generated.

The display control method also provides operational advantages similar to those described above.

Furthermore, the program according to the present embodiment causes a computer to execute the display control method.

The program also provides operational advantages similar to those described above.

In addition, in display control system 20 according to the present embodiment, each of the display modes of the videos is at least one of the position, posture, size of a corresponding one of the first display region and the second display region, color information about or luminance of the video displayed in the corresponding one of the first display region and the second display region, or presence/absence of a failure in the corresponding one of the first display region and the second display region.

With this, since analyzer 22 can analyze the display modes of the videos, and thus can cause first display screen 13a and second display screen 13b to display the videos which have been adjusted more appropriately. For this region, the occupant can see the videos having the whole sense of unity when looking at first display screen 13a and second display screen 13b.

In addition, in display control system 20 according to the present embodiment, the first display region is first display screen 13a for displaying a video, and the second display region is second display screen 13b for displaying a video. In addition, analyzer 22 analyzes the display mode of the video displayed on first display screen 13a and the display mode of the video displayed on second display screen 13b, based on the captured images obtained. Next, information generator 23 generates first display adjustment information for adjusting the display mode of the video displayed on first display screen 13a based on the result of the analysis by analyzer 22, and outputs the first display adjustment information generated; and generates second display adjustment information for adjusting the display mode of the video displayed on second display screen 13b based on the result of the analysis by analyzer 22, and outputs the second display adjustment information generated.

With this, it is possible to analyze the display modes of the videos displayed on first display screen 13a and second display screen 13b, and feed back the first display adjustment information for adjusting the display mode of the video displayed on first display screen 13a to first display screen 13a and feed back the second display adjustment information for adjusting the display mode of the video displayed on second display screen 13b to second display screen 13b. For this reason, since the adjusted videos are displayed on first display screen 13a and second display screen 13b, the occupant can see the videos having the whole sense of unity when looking at first display screen 13a and second display screen 13b.

In addition, display control system 20 according to the present embodiment further includes obtainer 21 which obtains captured images. Obtainer 21 is a camera capable of imaging the inside of vehicle 2.

With this, by imaging the inside of vehicle 2, obtainer 21 is capable of obtaining captured images including display screen 13 newly disposed. For this reason, analyzer 22 is capable of analyzing the position, posture, size, etc., of display screen 13 newly disposed. Information generator 23 is capable of generating display adjustment information for adjusting the display mode of the video displayed on display screen 13 newly disposed, based on the result of the analysis by analyzer 22, and outputting the display adjustment information. For this reason, in display control system 20, it is possible to easily adjust the video that is displayed on display screen 13 newly disposed inside vehicle 2 without sequentially making settings for display screen 13 newly disposed.

In addition, analyzer 22 is capable of identifying display screen 13 which is out of order among first display screen 13a and second display screen 13b arranged. For this reason, there is no need to check whether each of first display screen 13a and second display screen 13b is out of order.

### Variation 1 of Embodiment

The present variation is different from the embodiment in that captured images include occupant's head or eyes. The elements in the present variation are similar to those of the embodiment unless particularly specified, and thus the same elements are assigned with the same numerical references, and detailed descriptions of the same elements are omitted.

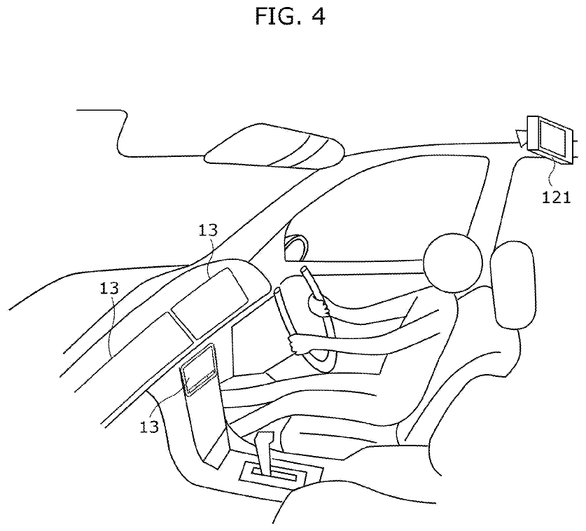

First, display system 1 according to the present variation is described with reference to FIG. 4.

FIG. 4 is a schematic diagram illustrating display system 1 according to Variation 1 of the embodiment.

Obtainer 121 in the present variation is a camera. Obtainer 121 is disposed on a ceiling, or the like in the room of vehicle 2. Obtainer 121 is capable of imaging first display screen 13a and second display screen 13b, and occupant's head or eyes who is in vehicle 2. For this reason, obtainer 121 is capable of obtaining captured images in which first display screen 13a and second display screen 13b, and the occupant's head or eyes who is in vehicle 2 are included.

Analyzer 22 analyzes the display mode of the video displayed on first display screen 13a and the display mode of the video displayed on second display screen 13b. Analyzer 22 further analyzes the position(s) of the occupant's head or eyes based on the captured images. Specifically, analyzer 22 extracts the occupant's head or eyes included in the captured images, and analyzes and identifies the position(s) of the occupant's head or eyes extracted. The position(s) of the occupant's head or eyes are, for example, relative position(s) relative to the position of predetermined display screen 13, the position of obtainer 121, or a predetermined position inside the room of vehicle 2. Analyzer 22 outputs an analysis result indicating the analyzed display mode of the video displayed on first display screen 13a and the analyzed display mode of the video displayed on second display screen 13b, and the position(s) of the occupant's head or eyes.

Information generator 23 obtains the result of the analysis by analyzer 22. Information generator 23 generates display adjustment information for individually adjusting the display mode of the video displayed on first display screen 13a and display adjustment information for individually adjusting the display mode of the video displayed on second display screen 13b, based on the result of the analysis by analyzer 22 which includes the display mode of the video displayed on first display screen 13a and the display mode of the video displayed on second display screen 13b, and the position(s) of the occupant's head or eyes. Information generator 23 outputs the generated display adjustment information for individually adjusting the display mode of the video displayed on first display screen 13a and the generated display adjustment information for individually adjusting the display mode of the video displayed on second display screen 13b.

In this way, display control system 20 is capable of adjusting the size of the video on first display screen 13a and the size of the video on second display screen 13b, suitably for the position(s) of the occupant's head or eyes by identifying the positions, postures, etc., of first display screen 13a and second display screen 13b and the position(s) of the occupant's head or eyes. For this reason, the occupant can see the videos on first display screen 13a and second display screen 13b having the whole sense of unity adjusted.

### <Processing Operation>

A description is given of processing operations by display control system 20, a display control method, and a program according to Variation 2 of the present embodiment.

### Operation Examples

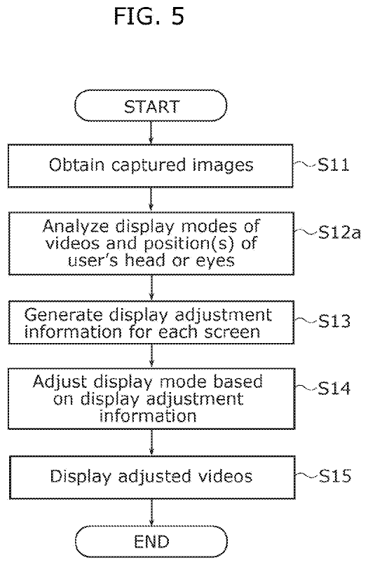

An operation example is described with reference to FIG. 5. FIG. 5 is a flowchart indicating an example of an operation that is performed by display system 1 according to Variation 1 of the embodiment. The present operation example is provided assuming a case where captured images include first display screen 13a of first display device 11 and second display screen 13b of second display device 12. In the present operation example, descriptions of processing similar to those provided for the operation example with reference to FIG. 3 in the embodiment are omitted appropriately.

First, upon obtaining captured images through the processing in Step S11, analyzer 22 analyzes the display mode of the video displayed on first display screen 13a and the display mode of the video displayed on second display screen 13b, and the position(s) of the occupant's head or eyes (S12a).

Specifically, analyzer 22 extracts, from the captured images, first display screen 13a, second display screen 13b, and the occupant's head or eyes. Analyzer 22 analyzes at least one of the position, posture, or size of each of first display screen 13a and second display screen 13b extracted, color information about or luminance of each video, or presence/absence of a failure of the corresponding one of first display screen 13a and second display screen 13b extracted. In addition, analyzer 22 analyzes the position(s) of the occupant's head or eyes extracted. Analyzer 22 outputs, to information generator 23, an analysis result indicating the analyzed display mode of the video displayed on first display screen 13a and the analyzed display mode of the video displayed on second display screen 13b, and the position(s) of the occupant's head or eyes.

Next, information generator 23 obtains, from analyzer 22, the result indicating the display mode of the video displayed on first display screen 13a and the display mode of the video displayed on second display screen 13b. Information generator 23 generates display adjustment information for individually adjusting the display mode of the video displayed on first display screen 13a and display adjustment information for individually adjusting the display mode of the video displayed on second display screen 13b, based on the result of the analysis by analyzer 22 which includes the display mode of the video displayed on first display screen 13a and the display mode of the video displayed on second display screen 13b, and the position(s) of the occupant's head or eyes (S13). Information generator 23 outputs the generated display adjustment information for individually adjusting the display mode of the video displayed on first display screen 13a and the generated display adjustment information for individually adjusting the display mode of the video displayed on second display screen 13b.

Specifically, based on the result of the analysis by analyzer 22, information generator 23 generates first display adjustment information for adjusting the display mode of the video displayed on first display screen 13a and second display adjustment information for adjusting the display mode of the video displayed on second display screen 13b. Information generator 23 outputs the first display adjustment information generated to first display controller 31 and outputs the second display adjustment information generated to second display controller 32.

Next, upon obtaining the display adjustment information for each display screen, display controller 30 generates a rendering command for executing processing for rendering a video for display on a corresponding one of first display screen 13a and second display screen 13b, based on the display adjustment information obtained. In other words, since the position(s) of the occupant's head or eyes have been identified, display controller 30 generates a rendering command for changing the display mode for first display screen 13a and a rendering command for changing the display mode for second display screen 13b according to the position(s) of the occupant's head or eyes, and adjusts the display mode of the video for display on first display screen 13a by executing the rendering processing based on the rendering command generated and adjusts the display mode of the video for display on second display screen 13b by executing the rendering processing based on the rendering command generated.

Specifically, upon receiving the first display adjustment information, first display controller 31 generates the rendering command for executing processing for rendering the video that is displayed on first display screen 13a, based on the first display adjustment information obtained. Likewise, upon receiving the second display adjustment information, second display controller 32 generates the rendering command for executing processing for rendering the video that is displayed on second display screen 13b, based on the second display adjustment information obtained. Each of first display controller 31 and second display controller 32 executes the rendering processing based on the rendering command generated according to the position(s) of the occupant's head or eyes, and adjusts the display mode of the video that is displayed on the corresponding one of first display screen 13a and second display screen 13b. First display controller 31 outputs the video on which the rendering processing has been executed to first display device 11. Second display controller 32 outputs the video on which the rendering processing has been executed to second display device 12.

Through Step S15, the processing operation in the flowchart in FIG. 5 is then ended, and a similar processing operation is repeated from Step S11.

In this way, even when the position(s) of the occupant's head or eyes has/have changed, it is possible to adjust the display mode of the video that is displayed on first display screen 13a and the display mode of the video that is displayed on second display screen 13b according to the position(s) of the occupant's head or eyes, and thus it is possible to provide the occupant with videos having the whole sense of unity on first display screen 13a and second display screen 13b.

In display system 20 according to the present variation, such captured images further include the head or eyes of the occupant in vehicle 2. In addition, analyzer 22 further analyzes the position(s) of the occupant's head or eyes based on the captured images. Information generator 23 generates display adjustment information for adjusting the display mode of a video displayed on a first display region and display adjustment information for adjusting the display mode of a video displayed on a second display region, based on the result of the analysis by analyzer 22 which includes the display mode of the video displayed on the first display region and the display mode of the video displayed on the second display region, and the position(s) of the occupant's head or eyes, and outputs the generated display adjustment information for adjusting the display mode of a video displayed on a first display region and the generated display adjustment information for adjusting the display mode of a video displayed on a second display region.

With this, by identifying the position(s) of the occupant's head or eyes, it is possible to cause first display screen 13a and second display screen 13b to display the videos which have been adjusted more appropriately according to the position(s) of the occupant's head or eyes. For this region, the occupant can see the videos having the whole sense of unity when looking at first display screen 13a and second display screen 13b.

### Variation 2 of Embodiment

The present variation is different from the embodiment in that other monitors are controlled in accordance with the monitor nearest to an occupant. The elements in the present variation are similar to those of the embodiment unless particularly specified, and thus the same elements are assigned with the same numerical references, and detailed descriptions of the same elements are omitted.

First, display system 1 according to the present variation is described. The elements in the present variation are similar to those in the embodiment, and thus are described with reference to FIG. 1.

In vehicle 2 according to the present variation, a plurality of display screens 13 for displaying videos including first display screen 13a and second display screen 13b are arranged. The plurality of display screens 13 are one example of the plurality of display regions.

Obtainer 21 is capable of obtaining captured images including the plurality of display screens 13.

Analyzer 22 identifies two or more (some of) display screens 13 from among the plurality of display screens 13.

Specifically, analyzer 22 further identifies predetermined display screens 13 which is a reference from among the plurality of display screens 13. Here, predetermined display screen 13 is for example, display screen 13 which is nearest to the occupant's head or eyes, display screen 13 which is most likely to be visually recognized by the occupant, display screen 13 which displays information about safety, display screen 13 which is specified by the occupant, or display screen 13 which is set optionally.

When analyzer 22 identifies predetermined screen 13 which is the reference, analyzer 22 also identifies, from among the plurality of display screens 13, display screens 13 other than predetermined display screen 13. Other display screens 13 are, for example, nearby display screen 13 which is present within a predetermined distance or range from predetermined display screen 13, nearby display screen 13 which is present in the field of view of the occupant, display screen 13 which is present within a predetermined distance from occupant's head or eyes, display screen 13 which is present around predetermined display screen 13, etc. Analyzer 22 analyzes the display mode of the video displayed on each display screen 13 identified. Analyzer 22 outputs an analysis result indicating the display mode of the video displayed on predetermined display screen 13 analyzed and the display mode of the video displayed on each of other display screens 13.

Information generator 23 obtains the result of the analysis by analyzer 22. Information generator 23 generates display adjustment information for individually adjusting the display mode of the video displayed on predetermined display screen 13 identified and display adjustment information for individually adjusting the display mode of the video displayed on each of other display screens 13 identified, based on the analysis result by analyzer 22 including the display mode of the video displayed on predetermined display screen 13 analyzed and the display mode of the video displayed on each of other display screens 13. Information generator 23 outputs display adjustment information for adjusting each of the display modes of the videos so that the occupant can see the videos similarly when looking at predetermined display screen 13 and other display screens 13.

In this case, information generator 23 may generate, for each of other display screens 13, display adjustment information for other display screen 13 so that the display mode for other display screen 13 becomes similar to the display mode for predetermined display screen 13 analyzed. In addition, when it is impossible to adjust the display mode of any of other display screens 13 in accordance with the display mode of predetermined display screen 13 analyzed, information generator 23 may generate display adjustment information indicating the display mode of other display screen which has been made closer to the display mode of predetermined display screen 13. In addition, information generator 23 may generate display adjustment information for adjusting predetermined display screen 13 and generate, for each of other display screens 13, display adjustment information for adjusting other display screen 13, so that the display mode of predetermined display screen 13 and the display mode of each of other display screens 13 become closer to each other.

### <Processing Operation>

A description is given of processing operations by display control system 20, a display control method, and a program according to the present embodiment.

### Operation Examples

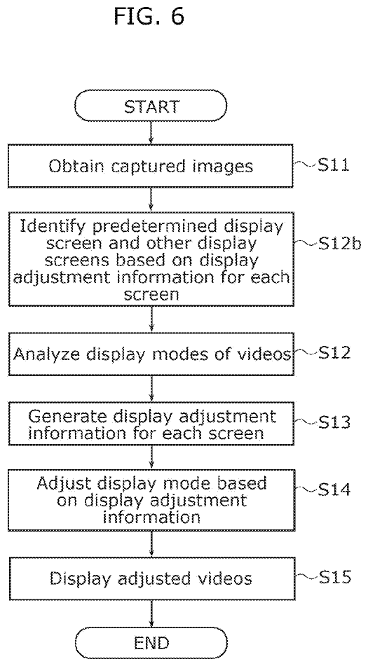

An operation example is described with reference to FIG. 6. FIG. 6 is a flowchart indicating an example of an operation that is performed by display system 1 according to Variation 2 of the embodiment. The present operation example assumes a case in which captured images include a plurality of display screens 13. In the present operation example, descriptions of processing similar to those provided for the operation example with reference to FIG. 3 in the embodiment are omitted appropriately.

First, through the processing in Step S11, analyzer 22 identifies predetermined display screen 13 which is a reference from among the plurality of display screens 13 and identifies other display screens 13 other than predetermined display screen 13 from among the plurality of display screens 13 (S12b).

Analyzer 22 analyzes the display mode of the video displayed on predetermined display screen 13 and the display mode of the video displayed on each of other display screens 13 identified (S12). Analyzer 22 outputs, to information generator 23, an analysis result indicating the display mode of the video displayed on predetermined display screen 13 and the display mode of the video displayed on each of other display screens 13.

Next, information generator 23 obtains the result of the analysis by analyzer 22. Information generator 23 generates display adjustment information for individually adjusting the display mode of the video displayed on predetermined display screen 13 and display adjustment information for individually adjusting the display mode of the video displayed on each of other display screens 13 identified, based on the analysis result by analyzer 22 indicating the display mode of the video displayed on predetermined display screen 13 and the display mode of the video displayed on each of other display screens 13 (S13). Information generator 23 outputs, to display controller 30, the display adjustment information for adjusting the display mode for predetermined display screen 13 and the display adjustment information for adjusting the display mode for each of other display screens 13 so that the display mode of predetermined display screen 13 and the display mode of each of other display screens 13 allow the occupant to recognize the videos having the sense of unity.

Next, through Steps S14 and S15, the processing operation in the flowchart in FIG. 6 is then ended, and a similar processing operation is repeated from Step S11.

In this way, since it is possible to adjust the display modes for other display screens 13 in accordance with the display mode of the video displayed on display screen 13 nearest to occupant's head or eyes, it is possible to provide the occupant with videos having the whole sense of unity on the plurality of display screens 13.

In display control system 20 according to the present variation, vehicle 2 includes a plurality of display regions for displaying videos (the plurality of display screens 13) including a first display region and a second display region. In addition, analyzer 22 identifies, from among the plurality of display regions, predetermined display region (predetermined display screen 13) and other display regions (other display screens 13) other than the predetermined display region. Information generator 23 then generates, for each of the predetermined display region and the other display regions identified, display adjustment information for adjusting the display mode of the video displayed on the predetermined display region and display adjustment information for adjusting the display mode of the video displayed on each of other display regions, and outputs the display adjustment information for the predetermined display region and the display adjustment information for each of the other display regions generated.

With this, by identifying predetermined display screen 13, it is possible to also identify other display screens 13 near predetermined display screen 13. For this reason, since it is possible to extract predetermined display screen 13 and other display screens 13 from among the plurality of display screens, it is possible to perform control so that only some of given display screens 13 among the plurality of display screens display videos which have been adjusted in a unified manner.

### Variation 3 of Embodiment

The present variation is different from the embodiment in that when ambient light is incident on a part of display screen 13, display screen 13 is classified into a display region in which ambient light is incident and a display region in which no ambient light is incident, and display adjustment is performed differently between the former region and the latter region. The elements in the present variation are similar to those of the embodiment unless particularly specified, and thus the same elements are assigned with the same numerical references, and detailed descriptions of the same elements are omitted.

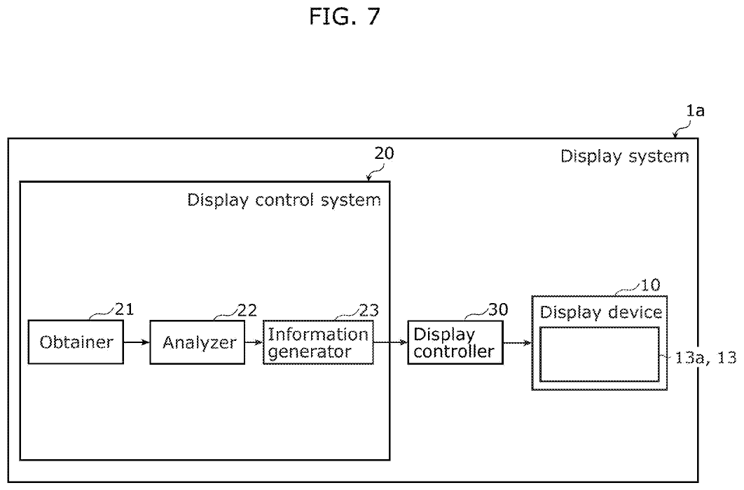

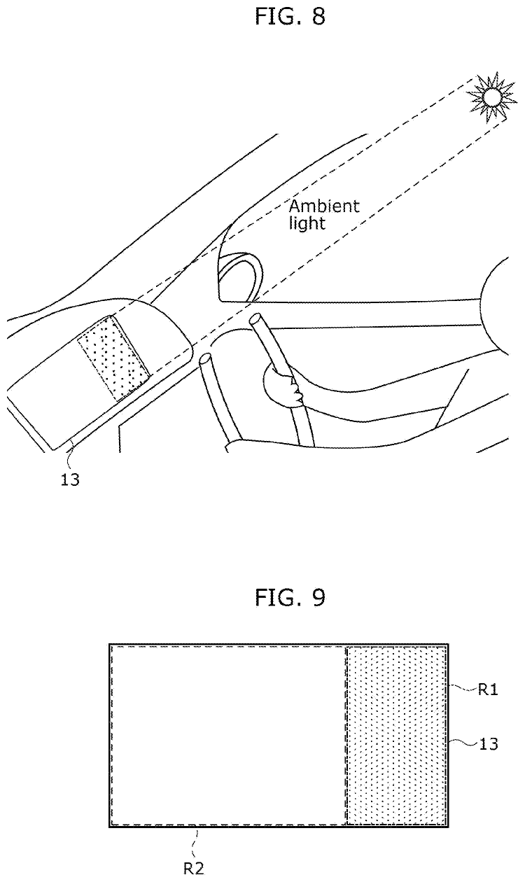

First, display system 1a according to the present variation is described with reference to FIGS. 7 to 9. FIG. 7 is a block diagram illustrating display system 1a according to Variation 3 of the embodiment. FIG. 8 is a schematic diagram illustrating display system 1a according to Variation 3 of the embodiment. FIG. 9 is a schematic diagram illustrating a state in which the part of display screens 13 is irradiated with ambient light.

In the present variation, first display region R1 is the region, of display screen 13 for displaying a video, which is irradiated with ambient light. On the other hand, second display region R2 is the region, of display screen 13 for displaying the video, which is not irradiated with ambient light.

Based on captured images obtained, analyzer 22 further identifies, in display screen 13, first display region R1 which is irradiated with ambient light and second display region R2 which is not irradiated with ambient light. Specifically, analyzer 22 extracts, from display screen 13, and identifies, in display screen 13, the region (first display region R1) which is irradiated with ambient light and the region (second display region R2) which is not irradiated with ambient light.

In addition, analyzer 22 analyzes the display mode of the video displayed on first display region R1 identified, based on the captured images obtained. In addition, analyzer 22 analyzes the display mode of the video displayed on second display region R2 identified, based on the captured images obtained. Analyzer 22 outputs an analysis result indicating the display mode of the video displayed on first display region R1 analyzed and the display mode of the video displayed on second display region R2 analyzed.

Information generator 23 obtains the result of the analysis by analyzer 22. Information generator 23 generates first partial display adjustment information for adjusting the display mode of the video displayed on first display region R1 based on the result obtained by analyzer 22 analyzing the display mode of the video displayed on first display region R1, and outputs the first partial display adjustment information generated. Likewise, information generator 23 generates second partial display adjustment information for adjusting the display mode of the video displayed on second display region R2 based on the result obtained by analyzer 22 analyzing the display mode of the video displayed on second display region R2, and outputs the second partial display adjustment information generated.

### <Processing Operation>

A description is given of processing operations by display control system 20, a display control method, and a program according to the present variation.

### Operation Examples

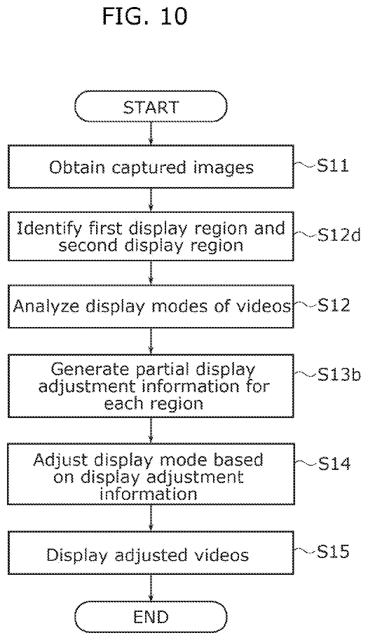

An operation example is described with reference to FIG. 10. FIG. 10 is a flowchart indicating an example of an operation that is performed by display system 1a according to Variation 3 of the embodiment. The present operation example assumes a case in which captured images include display screen 13 of single display device 10. It is to be noted that the present operation example is similar even in the case of display screens 13 of the plurality of display devices 10. In the present operation example, descriptions of processing similar to those provided for the operation example with reference to FIG. 3 in the embodiment are omitted appropriately.

First, through the processing in Step S11, analyzer 22 extracts and identifies first display region R1, of display screen 13, which is irradiated with ambient light and second display region R2, of display screen 13, which is not irradiated with ambient light (S12d). In other words, analyzer 22 also identifies the position, size, shape, etc., of each of first display region R1 and second display region R2 on display screen 13.

Next, upon obtaining the captured images, analyzer 22 analyzes the display mode of the video displayed on first display region R1 and the display mode of the video displayed on second display region R2, based on the captured images obtained.

Specifically, analyzer 22 analyzes the display mode of the video displayed on first display region R1 identified, based on the captured images obtained. Likewise, analyzer 22 analyzes the display mode of the video displayed on second display region R2 identified, based on the captured images obtained. Analyzer 22 outputs, to information generator 23, an analysis result indicating the display mode of the video displayed on first display region R1 analyzed and the display mode of the video displayed on second display region R2 analyzed.

Next, information generator 23 obtains the result of the analysis by analyzer 22. Based on the result of the analysis by analyzer 22, information generator 23 generates partial display adjustment information for individually adjusting the display mode of the video displayed on first display region R1 and partial display adjustment information for individually adjusting the display mode of the video displayed on second display region R2 (S13b). The partial display adjustment information includes first partial display adjustment information and second partial display adjustment information.

Specifically, information generator 23 generates the first partial display adjustment information for adjusting the display mode of the video displayed on first display region R1 based on the result obtained by analyzer 22 analyzing the display mode of the video displayed on first display region R1. Likewise, information generator 23 generates second partial display adjustment information for adjusting the display mode of the video displayed on second display region R2 based on the result obtained by analyzer 22 analyzing the display mode of the video displayed on second display region R2. Information generator 23 outputs the first partial display adjustment information and the second partial display adjustment information generated to display controller 30.

Next, upon obtaining the first partial display adjustment information and the second partial display adjustment information, display controller 30 generates rendering commands for executing rendering processing of the video that is displayed on display screen 13 based on the first partial display adjustment information and the second partial display adjustment information obtained. Display controller 30 executes the rendering processing based on the rendering commands generated, and adjusts the display modes of the video for display on display screen 13 (S14).

Specifically, display controller 30 obtains the first partial display adjustment information and the second partial display adjustment information. Display controller 30 divides display screen 13 into first display region R1 and second display region R2 based on the first partial display adjustment information and the second partial display adjustment information obtained. Display controller 30 generates a first rendering command for executing rendering processing of the video that is displayed on first display region R1 based on the first partial display adjustment information. Likewise, display controller 30 generates a second rendering command for executing rendering processing of the video that is displayed on second display region R2 based on the second partial display adjustment information. Display controller 30 executes the rendering processing based on the first rendering command generated, and adjusts the display mode of the video for display on first partial display region R1 of display screen 13. In addition, display controller executes the rendering processing based on the second rendering command generated, and adjusts the display mode of the video for display on second partial display region R2 of display screen 13. Display controller 30 outputs the video on which the rendering processing has been executed for each region to display device 10.

Next, upon the plurality of display devices 10 obtains, from display controller 30, the video adjusted based on the first partial display adjustment information and the video adjusted based on the second partial display adjustment information, the plurality of display devices 10 displays the videos obtained on display screen 13 (S15).

Specifically, upon the plurality of display devices 10 obtains, from display controller 30, the video that has been adjusted based on the first partial display adjustment information and the video that has been adjusted based on the second partial display adjustment information, the plurality of display devices 10 displays the videos obtained on display screen 13.

The processing operation in the flowchart in FIG. 10 is then ended, and a similar processing operation is repeated from Step S11.

In this way, even when the part of display screen 13 is irradiated with ambient light, it is possible to identify the region irradiated with ambient light and adjust display screen 13 in accordance with the display mode of the video in the region identified, and thus it is possible to provide the occupant with the video having the whole sense of unity on display screen 13. In addition, even when the plurality of display devices 10 is used, it is possible to adjust, for each of display devices 10, the display mode of a video on display screen 13 of display device 10 in accordance with the display mode of the video for display device 10, and thus it is possible to provide the videos on a plurality of display screens 13 with the whole sense of unity.

In display control system 20 according to the present variation, first display region R1 is a region, of display screen 13 for displaying a video, which is irradiated with ambient light. On the other hand, second display region R2 is a region, of display screen 13 for displaying a video, which is not irradiated with ambient light. In addition, analyzer 22 identifies first display region R1 and second display region R2 based on the captured images obtained, and based on the captured images: analyzes the display mode of the video displayed on first display region R1; and analyzes the display mode of the video displayed on second display region R2 identified. In addition, information generator 23: generates first partial display adjustment information for adjusting the display mode of the video displayed on first display region R1 based on the result obtained by analyzer 22 analyzing the display mode of the video displayed on first display region R1, and outputs the first partial display adjustment information generated; and generates second partial display adjustment information for adjusting the display mode of the video displayed on second display region R2 based on the result obtained by analyzer 22 analyzing the display mode of the video displayed on second display region R2, and outputs the second partial display adjustment information generated.

With this, even when ambient light is incident on the part of display screen 13, it is possible to identify the region on which ambient light is incident as first display region R1 and identify the region on which no ambient light is incident as second display region R2. For this reason, display control system 20 is capable of generating and outputting the first partial display adjustment information for adjusting the display mode of the video that is displayed on first display region R1 and the second partial display adjustment information for adjusting the display mode of the video that is displayed on second display region R2, so that the occupant can see the videos having the whole sense of unity on first display region R1 and second display region R2. As a result, since first display region R1 and second display region R2 display the videos which have been adjusted, the occupant can see the video having the whole sense of unity when looking at single display screen 13.

### Other Variations

Although the display control systems, the display control methods, and the programs according to the present disclosure have been described above based on the embodiment and variations thereof, the present disclosure is not limited to the embodiment and variations thereof. Embodiments obtainable by adding various kinds of modifications that a person skilled in the art would arrive at to any of the embodiment and variations thereof may be included in the scope of the present disclosure as long as such embodiments do not deviate from the sprit of the present disclosure.

For example, although the display modes of the videos on the plurality of display screens are automatically adjusted as described above in the display control system, the display control method, and the program according to each of the embodiment and variations thereof, an occupant may be able to manually adjust the display modes of videos on a plurality of display screens.

In addition, although the case where ambient light is different or changes in the display control system, the display control method, and the program according to each of the embodiment and variations thereof has been described above, such a case is a non-limiting example. For example, analyzer 22 may analyze the display modes of videos according to the degrees of one or more display devices 10 or arrangement positions of one or more display devices 10.

In addition, although analyzer 22 obtains, from the captured images, the display modes of the videos displayed in the display regions changes in the display control system, the display control method, and the program according to each of the embodiment and variations thereof as described above, analyzer 22 may obtain the display modes of the videos displayed in the display regions from something other than the captured images. For example, analyzer 22 may obtain the size of display screen 13 from EDID. In addition, analyzer 22 may obtain the luminances of videos from an illuminance sensor.

Furthermore, the controller, etc., included in the display control system, the display control method, and the program according to each of the embodiment and variations thereof are each represented as an LSI that is typically an integrated circuit. These elements may be made as separate individual chips, or some or all of these elements may be integrated into a single chip.

The means for circuit integration is not limited to an LSI, and implementation with a dedicated circuit or a general-purpose processor is also available. It is also possible to use a Field Programmable Gate Array (FPGA) that is programmable after the LSI is manufactured, and a reconfigurable processor in which connections and settings of circuit cells within the LSI are reconfigurable.

It is to be noted that, in each of the embodiment and variations thereof, each element may be configured as dedicated hardware or implemented by executing a software program suitable for the element. Each element may be implemented by a program executer such as a CPU or a processor reading a software program recorded on a recording medium such as a hard disc or a semiconductor memory and executing the software program.

In addition, all the numerals used above is provided as examples for specifically describing the present disclosure, and thus the embodiment and variations thereof are not limited to the exemplary numerals.

Alternatively, the segmentation into functional blocks in each block diagram is an example, and thus some of the functional blocks may be implemented as a single functional block, one of the functional blocks may be divided into two or more blocks, or the functions of a functional block may be transferred to one of the other functional blocks. Alternatively, a single item of hardware or software may process the functions of two or more of the functional blocks having similar functions in parallel or in time division.

The execution order of the steps in each flowchart is an example for specifically describing the present disclosure, and thus execution orders other than the exemplary execution order is also possible. Alternatively, some of the steps may be executed at the same time (in parallel with) one of the other steps.

Hereinafter, descriptions are given of features of the display control system, display control method, and program described based on each of the embodiment and variations thereof.

### <Technique 1>

A display control system is a display control system which is for controlling a first display region and a second display region arranged in a vehicle, and which includes: an analyzer which obtains captured images of the first display region which displays a video and the second display region which displays a video, and analyzes, based on the captured images obtained, display modes which are a display mode of the video displayed in the first display region and a display mode of the video displayed in the second display region; and an information generator which generates, for each of the display modes, display adjustment information for adjusting the display mode, based on at least a result of analysis by the analyzer, and outputs the display adjustment information generated.

### <Technique 2>

The display control system according to Technique 1 in which each of the display modes is at least one of a position, posture, or size of a corresponding one of the first display region and the second display region, color information about or luminance of the video displayed in the corresponding one of the first display region and the second display region, or presence or absence of a failure in the corresponding one of the first display region and the second display region.

### <Technique 3>

The display control system according to Technique 1 or 2 in which each of the captured images obtained further includes a head or eyes of an occupant who is in the vehicle, the analyzer further analyzes a position of the head or positions of the eyes of the occupant based on the captured images obtained, and the information generator generates the display adjustment information for adjusting the display mode of the video displayed in the first display region and the display adjustment information for adjusting the display mode of the video displayed in the second display region, based on (i) the display mode of the video displayed in the first display region and the display mode of the video displayed in the second display region, and (ii) a result of the analysis by the analyzer obtained as the position of the head or the positions of the eyes of the occupant, and outputs the display adjustment information for adjusting the display mode of the video displayed in the first display region and the display adjustment information for adjusting the display mode of the video displayed in the second display region generated.

### <Technique 4>

The display control system according to Technique 1 or 2 in which the vehicle includes a plurality of display regions arranged which includes the first display region and the second display region, the analyzer further identifies a predetermined display region and another display region other than the predetermined display region from among the plurality of display regions, and the information generator generates, for each of the predetermined display region and the another display region identified, display adjustment information for adjusting a display mode of a video displayed therein, and outputs the display adjustment information generated.

### <Technique 5>

The display control system according to Technique 1 or 2 in which the first display region is a first display screen for displaying a video, the second display region is a second display screen for displaying a video, the analyzer analyzes the display mode of the video displayed on the first display screen and the display mode of the video displayed on the second display screen, based on the captured images obtained, and the information generator: generates first display adjustment information for adjusting the display mode of the video displayed on the first display screen, based on the result of the analysis by the analyzer, and outputs the first display adjustment information generated; and generates second display adjustment information for adjusting the display mode of the video displayed on the second display screen, based on the result of the analysis by the analyzer, and outputs the second display adjustment information generated.

### <Technique 6>

The display control system according to Technique 1 or 2 in which the first display region is a region, of a display screen for displaying the video, which is irradiated with ambient light, the second display region is a region, of the display screen for displaying the video, which is not irradiated with ambient light, the analyzer: identifies the first display region and the second display region based on the captured images obtained; analyzes the display mode of the video displayed in the first display region identified, based on the captured images obtained; and analyzes the display mode of the video displayed in the second display region identified, based on the captured images, and the information generator: generates first partial display adjustment information for adjusting the display mode of the video displayed in the first display region based on the result of the analysis by the analyzer performed regarding the display mode of the video displayed in the first display region, and outputs the first partial display adjustment information generated; and generates second partial display adjustment information for adjusting the display mode of the video displayed in the second display region based on the result of the analysis by the analyzer performed regarding the display mode of the video displayed in the second display region, and outputs the second partial display adjustment information generated.

### <Technique 7>

The display control system according to any one of Technique 1 to 6 further includes an obtainer which obtains the captured images, and in which the obtainer is a camera capable of imaging inside the vehicle.

### <Technique 8>

A display control method is a display control method for controlling a first display region and a second display region arranged in a vehicle, and includes: obtaining captured images of the first display region which displays a video and the second display region which displays a video; analyzing, based on the captured images obtained, display modes which are a display mode of the video displayed in the first display region and a display mode of the video displayed in the second display region; and generating, for each of the display modes, display adjustment information for adjusting the display mode, based on at least a result of the analyzing, and outputting the display adjustment information generated.

### <Technique 9>

A program for causing a computer to execute the display control method according to Technique 8.

### <Technique 10>

A recording medium storing recorded thereon a program for causing a computer to execute the display control method according to Technique 8.

It is to be noted that the present disclosure also encompasses embodiments obtainable by adding various kinds of modifications that a person skilled in the art would arrive at to any of the embodiment and variations thereof, and embodiments obtainable by optionally combining any of the elements and functions in the embodiment and variations thereof within the scope and sprit of the present disclosure.

Further Information about Technical Background to this Application

The disclosure of the following patent application including specification, drawings, and claims are incorporated herein by reference in their entirety: Japanese Patent Application No. 2022-126084 filed on Aug. 8, 2022

### INDUSTRIAL APPLICABILITY

The present disclosure is applicable to, for example, vehicles, devices other than vehicles, and systems on each of which a plurality of display devices is mounted.

1. A display control system for controlling a first display region and a second display region arranged in a vehicle, the display control system comprising:
an analyzer which obtains captured images of the first display region which displays a video and the second display region which displays a video, and analyzes, based on the captured images obtained, display modes which are a display mode of the video displayed in the first display region and a display mode of the video displayed in the second display region; and
an information generator which generates, for each of the display modes, display adjustment information for adjusting the display mode, based on at least a result of analysis by the analyzer, and outputs the display adjustment information generated.

2. The display control system according to claim 1,
wherein each of the display modes is at least one of a position, posture, or size of a corresponding one of the first display region and the second display region, color information about or luminance of the video displayed in the corresponding one of the first display region and the second display region, or presence or absence of a failure in the corresponding one of the first display region and the second display region.

3. The display control system according to claim 1,
wherein each of the captured images obtained further includes a head or eyes of an occupant who is in the vehicle,
the analyzer further analyzes a position of the head or positions of the eyes of the occupant based on the captured images obtained, and
the information generator generates the display adjustment information for adjusting the display mode of the video displayed in the first display region and the display adjustment information for adjusting the display mode of the video displayed in the second display region, based on (i) the display mode of the video displayed in the first display region and the display mode of the video displayed in the second display region, and (ii) a result of the analysis by the analyzer obtained as the position of the head or the positions of the eyes of the occupant, and outputs the display adjustment information for adjusting the display mode of the video displayed in the first display region and the display adjustment information for adjusting the display mode of the video displayed in the second display region generated.

4. The display control system according to claim 1,
wherein the vehicle includes a plurality of display regions arranged which includes the first display region and the second display region,
the analyzer further identifies a predetermined display region and another display region other than the predetermined display region from among the plurality of display regions, and
the information generator generates, for each of the predetermined display region and the another display region identified, display adjustment information for adjusting a display mode of a video displayed therein, and outputs the display adjustment information generated.

5. The display control system according to claim 1,
wherein the first display region is a first display screen for displaying a video,
the second display region is a second display screen for displaying a video,
the analyzer analyzes the display mode of the video displayed on the first display screen and the display mode of the video displayed on the second display screen, based on the captured images obtained, and
the information generator:
generates first display adjustment information for adjusting the display mode of the video displayed on the first display screen, based on the result of the analysis by the analyzer, and outputs the first display adjustment information generated; and
generates second display adjustment information for adjusting the display mode of the video displayed on the second display screen, based on the result of the analysis by the analyzer, and outputs the second display adjustment information generated.

6. The display control system according to claim 1,
wherein the first display region is a region, of a display screen for displaying the video, which is irradiated with ambient light,
the second display region is a region, of the display screen for displaying the video, which is not irradiated with ambient light,
the analyzer:
identifies the first display region and the second display region based on the captured images obtained;
analyzes the display mode of the video displayed in the first display region identified, based on the captured images obtained; and
analyzes the display mode of the video displayed in the second display region identified, based on the captured images, and
the information generator:
generates first partial display adjustment information for adjusting the display mode of the video displayed in the first display region based on the result of the analysis by the analyzer performed regarding the display mode of the video displayed in the first display region, and outputs the first partial display adjustment information generated; and
generates second partial display adjustment information for adjusting the display mode of the video displayed in the second display region based on the result of the analysis by the analyzer performed regarding the display mode of the video displayed in the second display region, and outputs the second partial display adjustment information generated.

7. The display control system according to claim 1, further comprising:
an obtainer which obtains the captured images,
wherein the obtainer is a camera capable of imaging inside the vehicle.

8. A display control method for controlling a first display region and a second display region arranged in a vehicle, the display control method comprising:
obtaining captured images of the first display region which displays a video and the second display region which displays a video;
analyzing, based on the captured images obtained, display modes which are a display mode of the video displayed in the first display region and a display mode of the video displayed in the second display region; and
generating, for each of the display modes, display adjustment information for adjusting the display mode, based on at least a result of the analyzing, and outputting the display adjustment information generated.

9. A recording medium having recorded thereon a program for causing a computer to execute the display control method according to claim 8.
